(19) United States
(12) Patent Application Publication
(10) Pub. No.: US 2026/0325406 A1
(43) Pub. Date: Oct. 22, 2026

(54) MEDICATION BOTTLE CAP WITH INTEGRATED ALARM SYSTEM

(71) Applicant: Hannah Naude, Statesboro, GA (US)

(72) Inventor: Hannah Naude, Statesboro, GA (US)

(21) Appl. No.: 19/468,243

(22) Filed: Feb. 3, 2026

Related U.S. Application Data
(60) Provisional application No. 63/757,049, filed on Feb. 11, 2025.

(51) Int. Cl. A61J 7/04; A61J 1/03

(52) U.S. Cl. CPC A61J 7/0481; A61J 1/03

(57) ABSTRACT

A medication bottle cap is configured to be removably secured to a pill bottle and includes an integrated alarm system for reminding a patient to take a dose of medicine at a prescribed time. Once the alarm system has been activated, the alarm system is configured such that the medication bottle cap must be removed from the pill bottle before an alarm sound can be snoozed or dismissed. In some implementations, the medication bottle cap includes a time display module configured to display a current time, a speaker, a user interface, and a processing unit. The user interface includes a snooze input and a dismiss input, and is positioned on an underside of the medication bottle cap. The processing unit includes a memory configured to store at least one alarm time and is configured to cause the speaker to emit the alarm sound when the current time matches the at least one alarm time.

### CROSS-REFERENCE TO RELATED APPLICATION(S)

This application claims the benefit of U.S. Provisional Application Ser. No. 63/757,049, filed on Feb. 11, 2025, the entirety of which is incorporated herein by reference.

### TECHNICAL FIELD

This disclosure relates to a medication bottle cap with an integrated alarm system and to methods of using the medication bottle cap.

### BACKGROUND

Many patients are prescribed medications that are intended to be taken on a defined schedule. In practice, patients may miss doses, take doses late, or inadvertently take an incorrect dose due to forgetfulness, distractions, irregular daily routines, or other factors. Missed or delayed doses can reduce therapeutic effectiveness and may increase the likelihood of adverse outcomes in certain treatment regimens.

A variety of reminder approaches have been used to encourage medication adherence. Examples include mobile-device applications, wearable reminders, standalone alarm devices, and pill organizer. While such approaches may provide reminders, they can be separated from the medication container, ignored, silenced without accessing the medication, or otherwise fail to prompt the user to actually take the medication at the intended time.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and detailed description.

Disclosed are implementations of a medication bottle cap configured to be removably secured to a pill bottle containing solid medicine. The medication bottle cap includes an integrated alarm system for reminding a patient to take a dose of the solid medicine at a prescribed time. The alarm system is configured such that, when the alarm sound is active, the medication bottle cap must be removed from the pill bottle before the alarm sound can be snoozed or dismissed. This arrangement may increase patient compliance with medication adherence.

In one example implementation, a medication bottle cap configured to be removably secured to a pill bottle comprises a time display module configured to display a current time, a speaker, a user interface, and a processing unit. The user interface includes at least a snooze input and a dismiss input, the user interface being positioned on an underside of the medication bottle cap. The processing unit is operably coupled to the time display module, the speaker, and the user interface, and includes a memory configured to store at least one alarm time. The processing unit is configured to cause the speaker to emit an alarm sound when the current time matches the at least one alarm time. Further, when the medication bottle cap is secured to the pill bottle, the snooze input and the dismiss input are inaccessible for actuation such that the medication bottle cap must be removed from the pill bottle to actuate the snooze input or the dismiss input.

Also disclosed are implementations of a medication reminder system.

In one example implementation, a medication reminder system comprises a pill bottle and a medication bottle cap configured to be removably secured to the pill bottle. The medication bottle cap comprises a time display module configured to display a current time, a speaker, a user interface, and a processing unit. The user interface includes a snooze input and a dismiss input, and is disposed on an underside of the medication bottle cap. The processing unit is operably coupled to the time display module, the speaker, and the user interface, and includes a memory configured to store at least one alarm time. The processing unit is configured to cause the speaker to emit an alarm sound when the current time matches the at least one alarm time. Further, when the medication bottle cap is secured to the pill bottle, the user interface is inaccessible for actuation such that the medication bottle cap must be removed from the pill bottle to actuate the snooze input or the dismiss input.

Also disclosed are implementations of a method of reminding a patient to take a dose of medication from a pill bottle.

In one example implementation, a method of reminding a patient to take a dose of medication comprises providing a medication bottle cap. The medication bottle cap includes a time display module, a speaker, a snooze input and a dismiss input positioned on an underside of the medication bottle cap, and a processing unit including a memory storing at least one alarm time. The method further includes securing the medication bottle cap to the pill bottle; comparing, by the processing unit, a current time to the at least one alarm time; and, in response to the current time matching the at least one alarm time, causing the speaker to emit an alarm sound. The method also includes removing the medication bottle cap from the pill bottle to access the snooze input and the dismiss input, and receiving user actuation of the snooze input to snooze the alarm sound for a preset period of time.

Any aspect of any implementation, in combination with any one or more aspects of any other implementation(s).

Any one or more of the features disclosed herein.

Any one or more of the features as substantially disclosed herein.

Any one or more of the features as substantially disclosed herein, in combination with any one or more other features as substantially disclosed herein.

Any one of the aspects, features, or implementations, in combination with any one or more other aspects, features, or implementations.

Use of any one or more of the aspects or features disclosed herein.

It should be appreciated that any feature described herein can be claimed in combination with any other feature(s) described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIG. 1 is a perspective view of a pill bottle with an attached medication bottle cap incorporating an integrated alarm system according to the principles of the present disclosure.

FIG. 2 illustrates the pill bottle and the medication bottle cap shown in FIG. 1, wherein the medication bottle cap is shown detached from the pill bottle.

FIG. 3 illustrates a schematic representation of the integrated alarm system incorporated into the medication bottle cap.

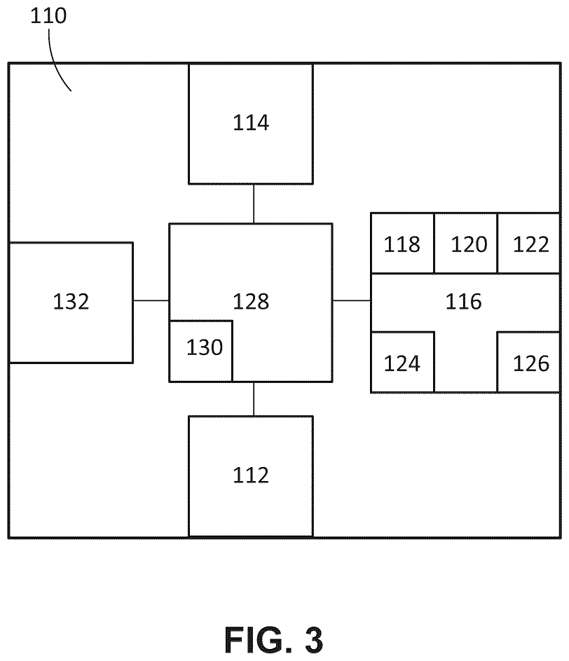

Like reference numerals refer to corresponding parts throughout the several views of the drawings.

### DETAILED DESCRIPTION

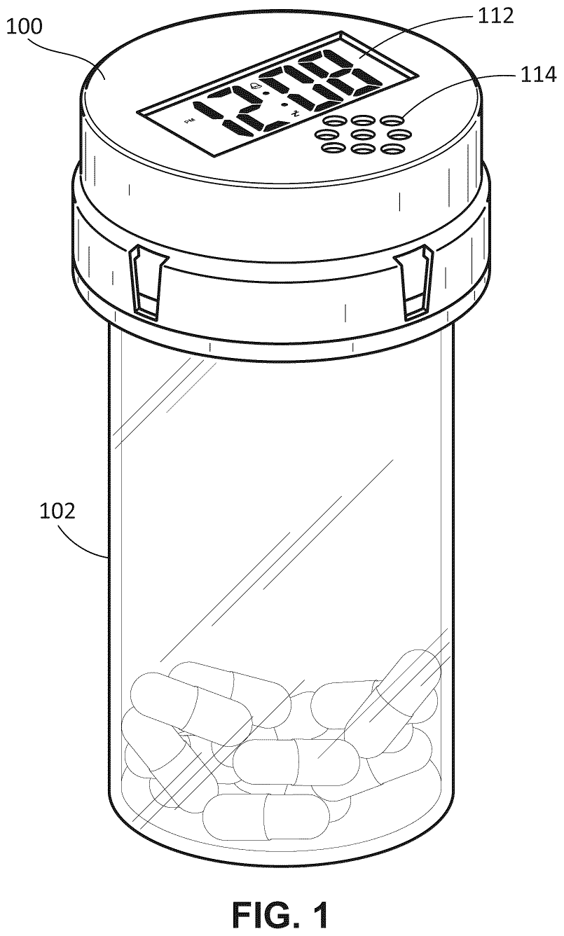

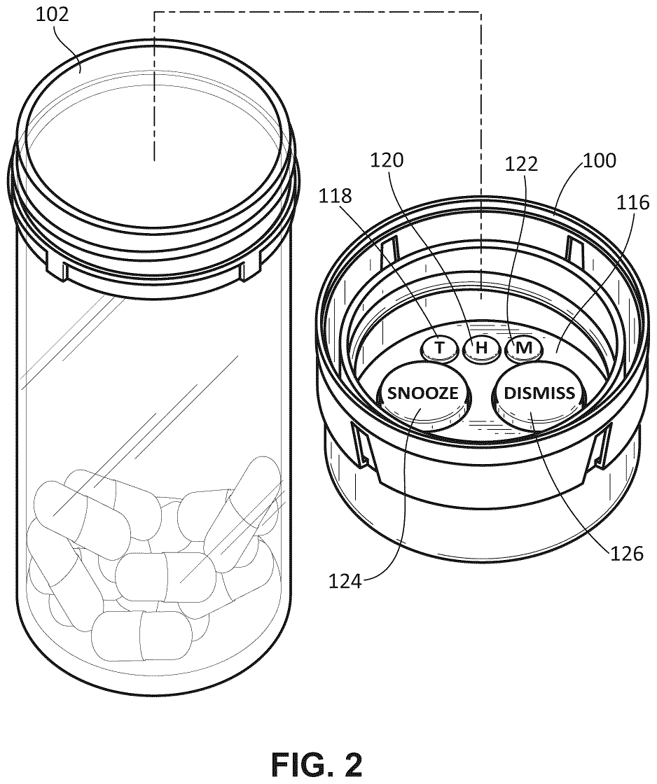

FIGS. 1 and 2 illustrate a medication bottle cap 100 according to the principles of the present disclosure. As shown in FIG. 1, the medication bottle cap 100 is configured to be removably secured to a pill bottle 102 containing solid medicine. As used herein, “solid medicine” refers to, without limitation, tablets, caplets, and capsules. The medication bottle cap 100 includes an integrated alarm system 110 for reminding a patient to take a dose of the solid medicine at a prescribed time. The alarm system 110 is configured such that, when the alarm sound is active, the medication bottle cap 100 must be removed from the pill bottle 102 before the alarm sound can be snoozed or dismissed. This arrangement may increase patient compliance with medication adherence and may be particularly useful for neurodivergent patients, such as those with ADHD.

The medication bottle cap 100 is configured to be removably secured to a pill bottle 102 that includes a child-resistant closure mechanism, which is well known to those of ordinary skill in the art. Typically, these closure mechanisms require simultaneous downward pressure and rotational motion to disengage the cap from the pill bottle 102. However, the medication bottle cap 100 may also be configured for use with a pill bottle that lacks child safety features.

The integrated alarm system 110 of the medication bottle cap 100 comprises a time display module 112, a speaker 114, and a user interface 116.

As shown in FIG. 1, the time display module 112, which is visible through an opening in the top surface of the medication bottle cap 100, is configured to display the current time. The time is presented in a standard 12-hour format with an AM or PM indicator displayed as appropriate. However, in other implementations, the time may alternatively be presented in a 24-hour format. The time display module 112 may be a monochrome or color liquid crystal display (LCD) module.

The speaker 114 is configured to provide an auditory signal (i.e., an alarm sound) when the alarm time is reached. The speaker 114 may comprise a transducer, positioned within the interior of the medication bottle cap 100, configured to generate an auditory signal that is transmitted through openings in the top surface of the medication bottle cap 100.

As shown in FIG. 2, the user interface 116, positioned on the underside of the medication bottle cap 100, allows a user to set the current time and input one or more desired alarm times. The user interface 116 may comprise five control buttons, including a first button 118 configured to toggle between AM and PM, a second button 120 configured to adjust the hour, a third button 122 configured to adjust the minute, a fourth button 124 configured to snooze the alarm sound, and a fifth button 126 configured to dismiss the alarm sound. Each button (118-126) is a pressure-activated switch. Because the user interface 116 is positioned on the underside of the medication bottle cap 100, the control buttons (118-126) are inaccessible when the medication bottle cap 100 is secured to the pill bottle 102, thereby requiring removal of the medication bottle cap 100 to actuate the control buttons (118-126).

The integrated alarm system 110 further comprises a processing unit 128 operably coupled to the time display module 112, the speaker 114, and the user interface 116. The processing unit 128 includes a memory 130 and a power source 132. The processing unit 128 may be an off-the-shelf microprocessor or an application-specific integrated circuit (ASIC). The memory 130 may comprise non-volatile storage, such as electronically erasable programmable read-only memory (EEPROM), to retain stored alarm system settings even when power is lost. The power source 132 may be a battery positioned within the interior of the medication bottle cap 100, providing energy to the processing unit 128 and other electrical components of the integrated alarm system 110. In some implementations, the power source 132 comprises a replaceable coin-cell battery housed in a battery compartment. In some implementations, the power source 132 comprises a rechargeable battery, and the medication bottle cap 100 includes a charging interface, such as a USB connector, for recharging the rechargeable battery.

The processing unit 128 is configured to receive user input to set the current time, receive user input specifying an alarm time, store the alarm time in memory 130, compare the current time with the alarm time stored in the memory 130, and trigger the speaker 114 to emit an alarm sound when the current time matches a stored alarm time. In some implementations, the processing unit 128 determines a match when an hour value and a minute value of the current time are equal to corresponding hour and minute values of the stored alarm time. The alarm sound may include a series of beeps, a continuous tone, or another alarm sound. The processing unit 128 may store a plurality of alarm times in the memory 130 and may trigger the speaker 114 to emit the alarm sound when the current time matches any of the plurality of alarm times.

The processing unit 128 is also configured to snooze the alarm sound for a preset period of time, such as 15 seconds, when the user presses the fourth button 124, allowing the user time to take the prescribed medication. Further, the fifth button 126 remains disabled until the fourth button 124 has been pressed and the preset snooze period has elapsed. Accordingly, the duration between pressing the fourth button 124 and the expiration of the preset snooze period serves as a lockout period for the fifth button 126, thereby further encouraging the patient to take the prescribed medication during the lockout period. While the preset snooze period is described as being 15 seconds, it should be understood that the preset snooze period may alternatively be set to a duration shorter or longer than 15 seconds. The processing unit 128 is further configured to dismiss the alarm sound when the fifth button 126 is pressed. Once the alarm sound is dismissed, it remains inactive until the next scheduled alarm time is reached.

Unless otherwise indicated, it should be understood that suitable wiring, traces, or a combination thereof, connect the power source 132 and electrical components of the integrated alarm system 110 disclosed herein.

### Operation and Use

Initially, while the medication bottle cap 100 is removed, the user interface 116 is used to set the time displayed by the time display module 112. The user interface 116 is then used to set an alarm time, which is the time at which a dose of the medication stored within the pill bottle 102 is to be taken. The medication bottle cap 100 is then secured to the top of the pill bottle 102.

When the current time matches a stored alarm time, the speaker 114 emits an alarm sound. The alarm sound persists until the user removes the medication bottle cap 100 from the pill bottle 102 to access the user interface 116. The user can then press the fourth button 124 to snooze the alarm system 110, temporarily stopping the alarm sound and providing time to take the prescribed medication. At the end of the lockout period, the alarm sound resumes. The user can then press the fifth button 126 to dismiss the alarm sound until the next scheduled alarm time and reattach the medication bottle cap 100 to the pill bottle 102.

The foregoing description of the present disclosure is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A medication bottle cap configured to be removably secured to a pill bottle, the
medication bottle cap comprising:
a time display module configured to display a current time;
a speaker;
a user interface including at least a snooze input and a dismiss input, the user interface being positioned on an underside of the medication bottle cap; and
a processing unit operably coupled to the time display module, the speaker, and the user interface, the processing unit including a memory storing at least one alarm time;
wherein the processing unit is configured to cause the speaker to emit an alarm sound when the current time matches the at least one alarm time; and
wherein, when the medication bottle cap is secured to the pill bottle, the snooze input and the dismiss input are inaccessible such that the medication bottle cap must be removed from the pill bottle to actuate the snooze input or the dismiss input.

2. The medication bottle cap of claim 1, wherein the processing unit is configured to snooze the alarm sound for a preset period of time in response to actuation of the snooze input.

3. The medication bottle cap of claim 2, wherein the processing unit is configured to disable actuation of the dismiss input until after actuation of the snooze input and expiration of the preset period of time.

4. The medication bottle cap of claim 1, wherein the processing unit is configured to store a plurality of alarm times in the memory and to cause the speaker to emit the alarm sound when the current time matches any of the plurality of alarm times.

5. The medication bottle cap of claim 1, wherein the time display module is visible through an opening in a top surface of the medication bottle cap.

6. The medication bottle cap of claim 1, wherein the speaker comprises a transducer positioned within an interior of the medication bottle cap.

7. The medication bottle cap of claim 1, further comprising a battery configured to supply power to the processing unit, the speaker, and the time display module.

8. A medication reminder system comprising:
a pill bottle; and
a medication bottle cap configured to be removably secured to the pill bottle, the medication bottle cap comprising:
a time display module configured to display a current time;
a speaker;
a user interface including a snooze input and a dismiss input, the user interface being disposed on an underside of the medication bottle cap; and
a processing unit operably coupled to the time display module, the speaker, and the user interface, the processing unit including a memory storing at least one alarm time;
wherein the processing unit is configured to cause the speaker to emit an alarm sound when the current time matches the at least one alarm time; and
wherein, when the medication bottle cap is secured to the pill bottle, the user interface is inaccessible for actuation such that the medication bottle cap must be removed from the pill bottle to actuate the snooze input or the dismiss input.

9. The medication reminder system of claim 8, wherein the processing unit is configured to snooze the alarm sound for a preset period of time in response to actuation of the snooze input.

10. The medication reminder system of claim 9, wherein the processing unit is configured to disable actuation of the dismiss input until after actuation of the snooze input and expiration of the preset period of time.

11. The medication reminder system of claim 8, wherein the processing unit is configured to store a plurality of alarm times in the memory and to cause the speaker to emit the alarm sound when the current time matches any of the plurality of alarm times.

12. The medication reminder system of claim 8, wherein the medication bottle cap includes an opening in a top surface through which the time display module is visible.

13. The medication reminder system of claim 8, wherein the speaker of the medication bottle cap comprises a transducer positioned within an interior of the medication bottle cap.

14. The medication reminder system of claim 8, wherein the medication bottle cap further comprises a battery configured to supply power to the processing unit, the speaker, and the time display module.

15. A method of reminding a patient to take a dose of medication from a pill bottle, the method comprising:
providing a medication bottle cap including a time display module, a speaker, a snooze input and a dismiss input positioned on an underside of the medication bottle cap, and a processing unit including a memory storing at least one alarm time;
securing the medication bottle cap to the pill bottle;
comparing, by the processing unit, a current time to the at least one alarm time;
in response to the current time matching the at least one alarm time, causing the speaker to emit an alarm sound;
removing the medication bottle cap from the pill bottle to access the snooze input and the dismiss input; and
receiving user actuation of the snooze input to snooze the alarm sound for a preset period of time.

16. The method of claim 15, further comprising receiving user actuation of the dismiss input to dismiss the alarm sound.

17. The method of claim 15, further comprising receiving user input specifying the at least one alarm time and storing the at least one alarm time in the memory of the processing unit.

18. The method of claim 15, further comprising, after expiration of the preset period of time, causing the speaker to resume emitting the alarm sound.

19. The method of claim 15, further comprising disabling the dismiss input during the preset period of time.

20. The method of claim 19, wherein receiving user actuation of the dismiss input occurs after expiration of the preset period of time.
